(19) United States
(12) Patent Application Publication
(10) Pub. No.: US 2022/0072695 A1
(43) Pub. Date: Mar. 10, 2022

(54) COMPRESSION OR CUTTING TOOL

(71) Applicant: CEMBRE S.P.A., Brescia (IT)

(72) Inventors: Giovanni ROSANI, Brescia (IT); Gualtiero BAREZZANI, Brescia (IT); Gianluca GIACOMAZZI, Brescia (IT)

(21) Appl. No.: 17/416,664

(22) PCT Filed: Dec. 21, 2018
(86) PCT No.: PCT/IB2018/060489

§ 371 Date: Jun. 21, 2021

(51) Int. Cl. B25F 5/00; B25B 27/10; B23D 29/00; F16H 25/22; F16H 57/08; F16H 25/24

(52) U.S. Cl. CPC B25F 5/001; B25B 27/10; F16H 25/24; F16H 25/2252; F16H 57/082; B23D 29/002

(57) ABSTRACT

A hand-held tool (1) manually operable to compress or cut, the tool (1) being elongated bar-shaped or gun-shaped and including a casing (2) forming a grip portion, a motor (3) supported by the casing (2), a reduction and conversion mechanism (5) supported by the casing (2) and connected to the motor (3) and to an actuating member (6). The reduction and conversion mechanism (5) is configured to make the actuating member (6) translate along an actuating axis (7) in response to a rotational motion of the motor (3). A working head (8), connected to the casing (2), interacts with the actuating member (6) so that the working head (8) performs a compression or cutting movement in response to the translation of the actuating member (6). The reduction and conversion mechanism (5) has a conversion mechanism (9) with a planetary roller screw (10, 12, 14).

The present invention relates to a compression or cutting tool, in particular to a hand-held tool.

Hydrodynamic compression and cutting tools are often used to carry out connection operations, e.g. compressing connectors about electric wires or for hydraulic pipes, compressing rivets, or for cutting operations, e.g. cutting electric wires during electric system installation and maintenance.

Such tools usually comprise an electric motor supplied by an accumulator and a hydraulic pump which causes an increase of pressure of a hydraulic liquid operating on a piston to move it against the bias of a pressure spring. In turn, the piston is connected to a pair of jaws of the tool so as to displace them, during the compression or cutting operation, with respect to each other. The jaws may be shaped and/or provided with interchangeable accessory elements so as to adapt to a particular object, e.g. an electrical contact or a hydraulic connector to be compressed or a metallic bar to be cut.

The electro-hydraulic systems for transforming the rotation of the motor shaft into a translational thrust are particularly suited for situations which require high forces or compression and/or cutting torques, but are expensive, bulky and require high maintenance, in addition to requiring the management of a hydraulic oil.

A direct application of the jaws to the rotation of the electric motor, possibly demultiplied by a reduction gear, cannot provide the compression and/or cutting torque or thrust necessary for the aforesaid applications, and is unacceptably cumbersome precisely at the jaws (tool head) which must be able to operate in limited space conditions.

A conversion of the rotational motion output from the electric motor into a translational motion of a piston by means of a screw and nut screw converter can be hypothesized, but cannot reconcile the need for miniaturization (in order to be able to be used in a hand-held tool) with the need to provide a necessary compression thrust. This is mainly due to the high shear stresses and friction of the ridges of the screw and nut screw thread.

An attempt to use a ball-screw converter also did not satisfy the contrasting needs of small size suited for hand-held tools and acceptably high compression thrust and would also be excessively costly. The reasons for this are the limited overall contact surface for the axial force transmission, the limited number of contact points of the balls with the threads of the screw and of the nut screw, the energy losses due to the mutual sliding contact of the balls and the waste of the space necessary for the return path of the balls. In addition, all the contemplated solutions require maintenance and have a limited service life due to the high stresses of the threads.

Therefore, it is the object of the present invention to improve the compression and/or cutting tools (in particular, the hand-held tools) to better reconcile the conflicting requirements of compactness on the one hand and the compression and/or cutting performance on the other.

It is a further object of the invention to suggest a compression and/or cutting tool (in particular a hand-held tool), the motion transmission and conversion mechanism of which is free from hydraulic systems (with the exception of lubrication systems), which has a reduced axial stress of the threads and/or of the gear teeth and, therefore, longer service life and lower maintenance requirements.

It is a further object of the invention to suggest a compression and/or cutting tool (in particular, a hand-held tool) with a motion transmission and conversion mechanism which is adapted for bar-shaped hand-held tools (line tools) and gun-shaped hand-held tools.

The object of the invention is achieved by means of a compression or cutting tool according to claim 1. The dependent claims relate to advantageous embodiments.

According to an aspect of the invention, a hand-held tool (1) manually operable to compress or cut, said tool (1) is shaped as an elongated bar or as a gun and comprises:

a casing (2) which forms a grip portion,

a motor (3) supported by the casing (2),

a reduction and conversion mechanism (5) supported by the casing (2) and connected to the motor (3) and to an actuating member (6), wherein the reduction and conversion gear (5) is configured to make the actuating member (6) translate along an actuating axis (7) in response to a rotational motion of the motor (3),

a working head (8) connected to the casing (2) and which interacts with the actuating member (6) so that the working head (8) performs a compression or cutting movement in response to the translation of the actuating member (6),

wherein the reduction and conversion mechanism (5) comprises a conversion mechanism (9) with a planetary roller screw (10, 12, 14).

According to a further aspect of the invention, a compression or cutting tool comprises:

a casing,

a motor (preferably electric), which can be powered by an accumulator or from the mains, said motor being arranged inside the casing,

a reduction and conversion gear arranged in the casing and connected to the motor and to an actuating member, the reduction and conversion gear being configured to make the actuating member translate along an actuating axis in response to a rotational motion of the motor,

a working head connected to the casing and which interacts with the actuating member so that the working head performs a compression or cutting movement in response to the translation of the actuating member,

characterized in that the reduction and conversion mechanism comprises a conversion mechanism with:

a nut screw with internal thread or multiple internal circumferential groove,

a screw coaxial and parallel with the nut screw, said screw having an external thread or multiple external circumferential groove not directly engaged with the nut screw,

a plurality of planetary screws parallel to the nut screw and interposed between the screw and the nut screw, wherein each of the planetary screws having an external thread or multiple external circumferential groove engaging with the thread or multiple circumferential groove of the screw and the nut screw,

a planetary carrier which supports each of the planetary screws in rotational manner about a planetary axis thereof parallel to the nut screw and at a fixed distance from the other planetary screws to prevent direct contact between them,

wherein the reduction and conversion mechanism transmits an input rotational motion to either one of said screw, nut or carrier or to the planetary screws,
wherein a plurality of engagements between at least one of said threads and a respective thread or multiple circumferential groove of said screw, nut screw and planetary screws convert said input rotational motion into an output translational motion of at least one other of said screw, nut screw and planetary carrier.

By virtue of the rolling engagement of a plurality of planetary screws with both the screw and the nut screw and of the possibility of increasing the overall contact surface area and the number of contact points by choosing the number of planetary screws and by choosing length, pitch and number of starts of the planetary screws, it is possible to reduce the axial stress on the individual ridges of the threads and to reduce the diameters of screw, planetary screws and nut screw, and consequently the radial dimensions of the conversion mechanism, by further exploiting its axial length which is accommodated by the translational stroke desired in all cases for actuating the working head.

In this manner, it is possible to reconcile the needs of compactness and performance of the tool better.

The miniaturization needed to accommodate a screw, a nut screw, a plurality of planetary screws and a planetary carrier (and some other components which will be described later) in a compression or cutting tool may appear counterproductive, because of the slender and apparently weak dimensions of the threads, of the necessary precision machining and of the relatively high costs.

However, experiments with prototypes and numeric simulations have shown that, by virtue of the distribution of the axial load on a number of pressure surfaces and higher cutting sections, the shearing stresses on the threads are considerably reduced, with the result that the individual components of the conversion mechanism, despite being miniaturized, are oversized with respect to the compression tools of the prior art and have a longer lifespan with less maintenance. These benefits outweigh the disadvantage of precision mechanical machining and the higher cost of manufacture.

In order to better understand the invention and appreciate its advantages, the description of some embodiments will be provided below by way of non-limiting examples with reference to the accompanying figures, in which:

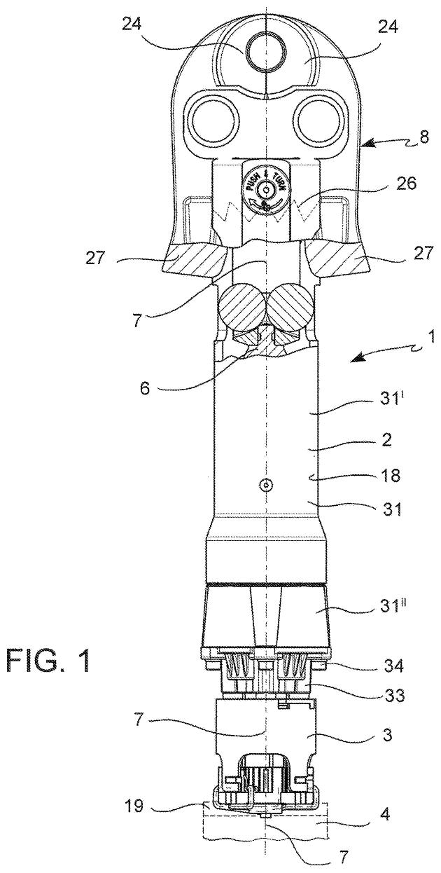

FIG. 1 is a side view of a compression/cutting tool according to an embodiment, in which one part of the casing has been removed,

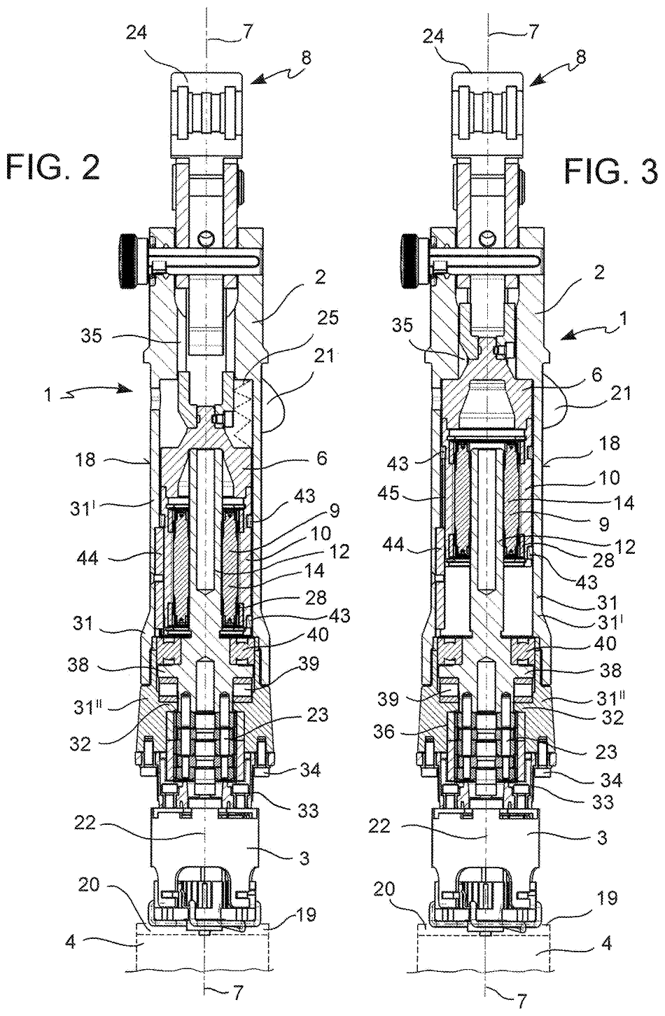

FIG. 2 is a longitudinal section side view of a compression/cutting tool according to an embodiment, in which the conversion mechanism is in retracted position,

FIG. 3 shows the same tool of FIG. 2, in which the conversion mechanism is in the advanced position,

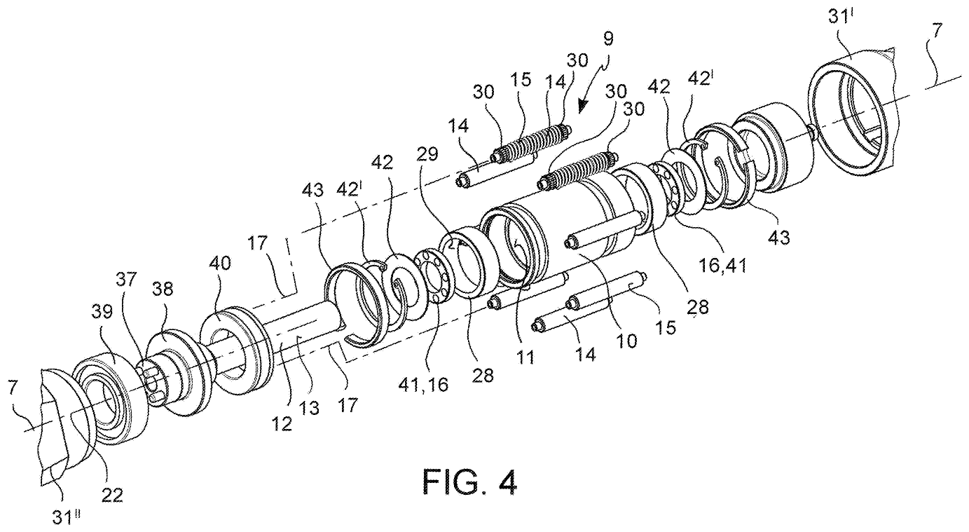

FIG. 4 is an exploded view of a conversion mechanism of the tool according to an embodiment,

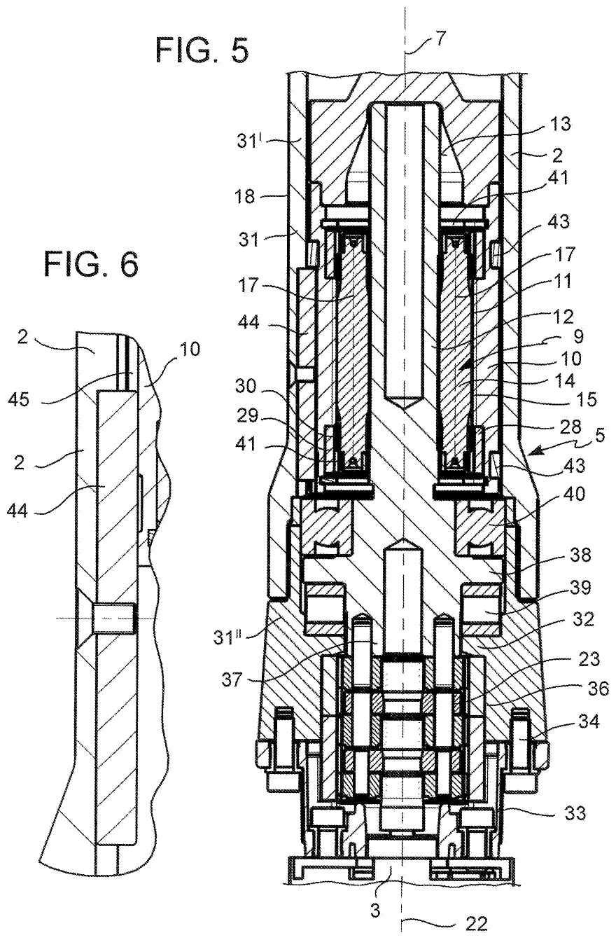

FIG. 5 is a longitudinal section side view of a reduction and conversion mechanism of the tool according to an embodiment,

FIG. 6 is an enlarged view of a detail in FIG. 5,

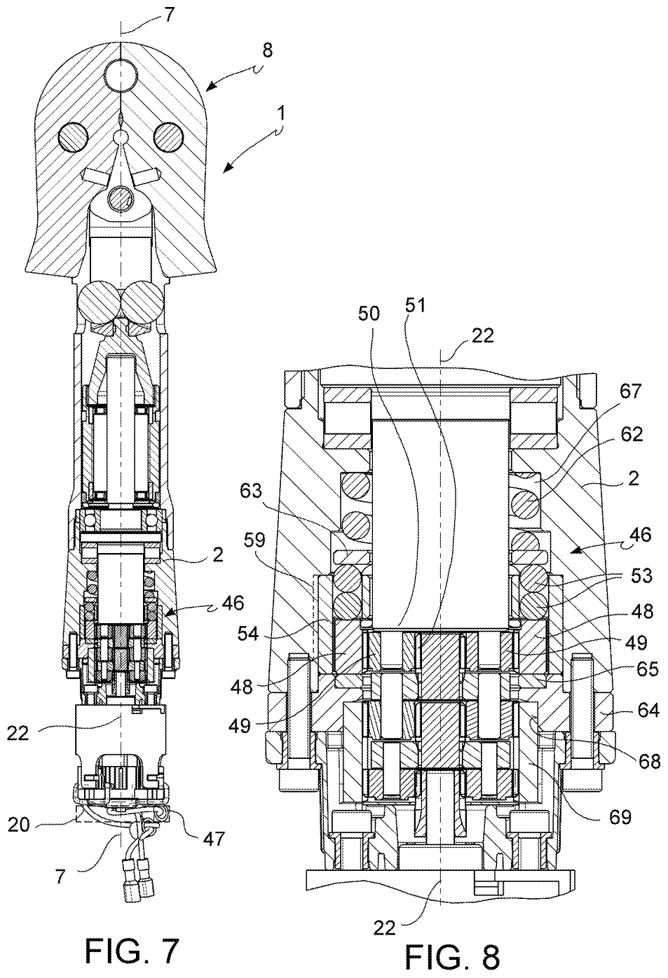

FIG. 7 is a longitudinal section side view of a compression or cutting tool with safety clutch according to a further embodiment,

FIG. 8 is an enlarged view of the safety clutch in FIG. 7;

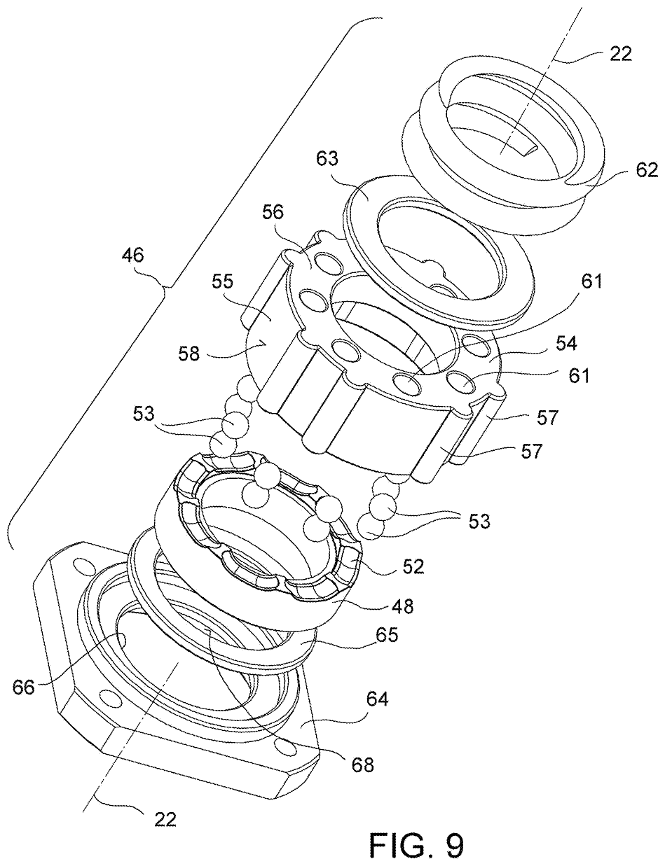

FIG. 9 is an exploded view of the safety clutch in FIG. 7,

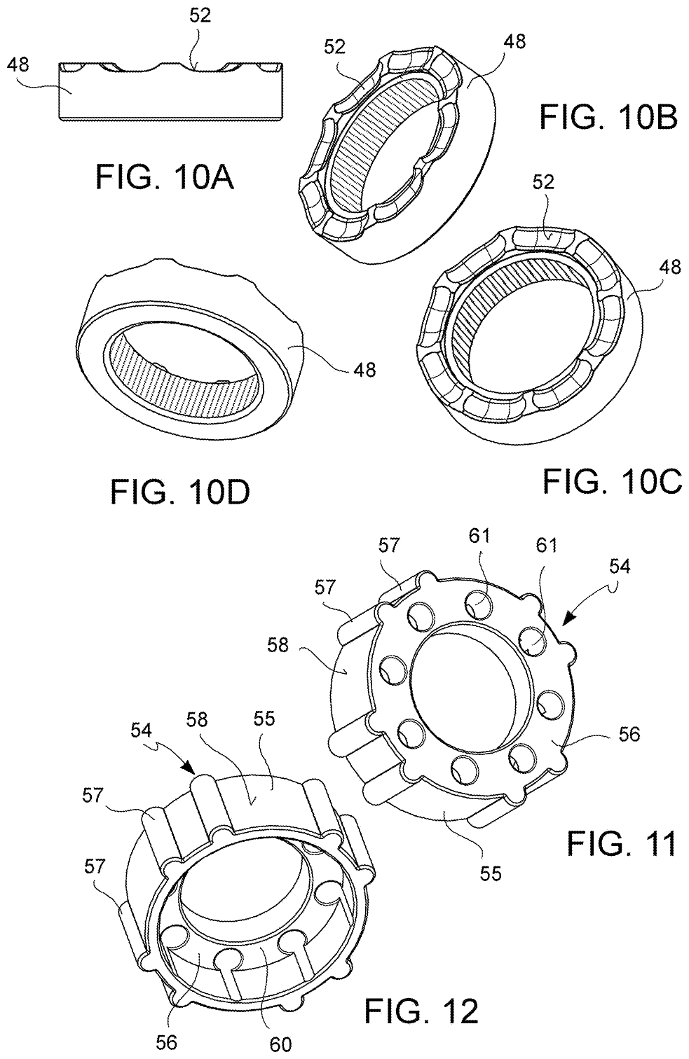

FIGS. 10A-10C are views of a ring gear of the safety clutch in FIG. 7,

FIGS. 11 and 12 are views of a clutch casing of the safety clutch in FIG. 7.

With reference to the figures, a compression or cutting tool 1 comprises a casing 2, a motor 3, preferably electric, which can be powered by an accumulator 4 or from the mains (not shown), said motor 3 being arranged in the casing 2. The tool 1 further comprises a reduction and conversion gear 5 arranged in the casing 2 and connected with the motor 3 and with an actuating member 6. The reduction and conversion gear 5 is configured to make the actuating member 6 translate along an actuating axis 7 in response to a rotational motion of the motor 3. A working head 8 is connected to the casing 2 and interacts with the actuating member 6 so that the working head 8 performs a compression or cutting movement in response to the translation of the actuating member 6.

According to an aspect of the invention, the reduction and conversion mechanism 5 comprises a conversion mechanism 9 with:

a nut screw 10 with internal thread 11 or multiple internal circumferential groove,

a screw 12 coaxial and parallel with the nut screw 10, said screw 12 having an external thread 13 or multiple external circumferential groove not directly engaged with the nut screw 10,

a plurality of planetary screws 14 parallel to the nut screw 10 and interposed between the screw 12 and the nut screw 10, wherein each of the planetary screws 14 has an external thread 15 or multiple external circumferential groove engaging with the thread or multiple circumferential groove of the screw 12 and the nut screw 10,

a planetary carrier 16 which supports the planetary screws 14:
so that each planetary screw can rotate about its own planetary axis 17 parallel to the nut screw 10, and
so that each planetary screw is at a preferably fixed distance from the other planetary screws 14 to prevent direct contact between them.

The reduction and conversion mechanism 5 transmits an input rotational motion to one of said screw 12, nut screw 10 or carrier 16 or to the planetary screws 14, and a plurality of engagements between at least one of said threads 11, 13, 15 and a respective thread 15, 11, 13 or multiple circumferential groove of said screw 12, nut screw 10 and planetary screws 14 convert said input rotational motion into an output translational motion of at least one other of said screw 12, nut screw 10 and planetary carrier 16 connected in turn to the actuating member.

By virtue of the rolling engagement of a plurality of planetary screws 14 with both the screw 12 and the nut screw 10 and of the possibility of increasing the overall contact surface area and the number of contact points by choosing the number of planetary screws 14 and by choosing length, pitch and number of starts of the planetary screws 14, as well as choosing pitch and number of starts of the screw 12 and of the nut screw 10, it is possible to reduce the axial stress on the individual ridges of the threads and to reduce the diameters of the screw 12, of the planetary screws 14 and the nut screw 10 and so the radial dimensions of the conversion mechanism 9, by further exploiting its axial length.

In this manner, it is possible to better reconcile the needs of compactness and performance of the tool 1.

Detailed Description of the Reduction and Conversion Mechanism 5

The reduction and conversion mechanism 5 may comprise a reducer 23, preferably epicyclic, e.g. with one or more stages, preferably with three stages, connected to the drive shaft of the motor 3 and configured to reduce the speed and increase the torque of the rotational movement generated by the motor 3. Preferably, the reduction gear 23 is arranged upstream of the conversion mechanism 9.

The conversion mechanism 9 may further be connected to the motor 3, or, if possible, to the reducer 23, in particular at the outlet of the epicyclic reducer, and configured to transform the rotational movement output from the motor 3 or from the reducer 23 into a reciprocating translational movement of the actuating member 6.

For example, a translational forward movement of the actuating member 6 can be achieved by means of a rotation of the motor shaft in a first direction and a translational movement of the return stroke of the actuating member 6 can be achieved by means of a rotation of the motor shaft in a second direction opposite to the first direction.

Alternatively, the reduction and conversion mechanism 5 may comprise means for inverting the translational motion, e.g. an inversion gear, which can be actuated e.g. as a function of the reaching of a limit stop position and a beginning of stroke position of the actuating member 6, or which can be actuated by means of the control circuit 20 in automatic mode or according to a control by the user.

According to an embodiment, the conversion mechanism 9 further comprises at least one, preferably two, ring gears 28 coaxial with the nut screw 10, the internal toothing 29 of which meshes with a corresponding external toothing 30 of each of the planetary screws 14 so as to synchronize the revolution movements around their own planetary axes 17 of all planetary screws 14. As explained above, the planetary carrier 16 instead synchronizes (if provided) the rotation movements of all the planetary screws 14 about the common central axis of the nut screw 10 and of the screw 12. Advantageously, the external toothing 30 is formed (with overlap) on the external thread 15 or multiple circumferential groove of the planetary screws 14, by means of axial grooves which cut the thread or multiple groove ridges, so as not to reduce the number of ridges which are useful for transmitting axial force (FIG. 4).

Advantageously, the ring gears 28 and the corresponding external teeth 30 of the planetary screws 14 are positioned at opposite end portions of the planetary screws 14 and, if the planetary carrier 16 translates together with the nut screw 10, also at opposite end portions of the nut screw 10.

In an embodiment, the rotation of one or more ring gears 28 is released from the rotation of the nut screw 10, of the screw 12 and possibly also of the planetary carrier 16. This floating arrangement of the ring gears 28 avoids jamming of the conversion mechanism 9 despite its inherent rigidity, due to the high number of contact points.

According to alternative embodiments, the rotation of one or more ring gears 28 is constrained to the rotation of the nut screw 10 or the rotation of the screw 12 or, possibly, also to the rotation of the planetary carrier 16. This arrangement further improves the rigidity and the immediate kinematic response (and travel speed) of the conversion mechanism 9.

The conversion mechanism 9 can perform the rotation-translation conversion by means of an engagement between thread and circumferential grooves perpendicular to the rotation axis of the screw members 10,12,14, but having pitch complementary with the pitch of the thread, or the conversion mechanism 9 can achieve the rotation-translation conversion by means of an engagement between two threads with complementary pitch but not necessarily with the same number of starts.

In the description of the general principles of the invention, it was highlighted that each of the screw 12, nut screw 10, planetary carrier 16 and planetary screw 14 components could act as an input component of the conversion mechanism 9 which receives the rotary motion from the reduction unit 23 or directly from the motor 3, and that respectively one of the other components, namely one chosen from screw 12, nut screw 10, planetary carrier 14 (but not a single planetary screw 14 and not the input component) could act as output component which translates with respect to the rotary input component. The condition is that the input component does not translate axially but can rotate (with respect to the casing 2), while the output component does not rotate but can translate axially (with respect to the casing 2).

Without listing them one by one here, the invention expressly contemplates all input component and output component combinations which meet the provided design constraints.

According to a preferred embodiment (FIGS. 2, 3, 5), the reduction and conversion mechanism 5 transmits the rotational motion to the screw 12 which is rotatable with respect to the casing 2 about the actuating axis 7 but stationary in translation with respect to the casing 2; the planetary carrier 16 is integral in rotation with the nut screw 10 and the nut screw 10 is integral in rotation with the casing 2, but can translate with respect to the casing 2 along the actuating axis 7, in which the nut screw 10 transmits its translational movement to the actuating member 6.

According to a further embodiment, the reduction and conversion mechanism 5 transmits the rotational motion to the nut screw 10 which is rotatable with respect to the casing 2 about the actuating axis 7 but stationary in translation with respect to the casing 2, the planetary carrier 16 is integral in rotation with the nut screw 10 and the screw 12 is integral in rotation with the casing 2, but can translate with respect to the casing 2 along the actuating axis 7, in which the screw 12 transmits its translational movement to the actuating member 6.

According to a further embodiment, the reduction and conversion mechanism 5 transmits the rotational motion to the nut screw 16 which is rotatable with respect to the casing 2 about the actuating axis 7 but stationary in translation with respect to the casing 2, the planetary carrier 16 is integral in rotation with the nut screw 10, also integral in translation with the casing 2, and the screw 12 is integral in rotation with the casing 2, but can translate with respect to the casing 2 along the actuating axis 7, in which the screw 12 transmits its translational movement to the actuating member 6.

According to a further embodiment, the reduction and conversion mechanism 5 transmits the rotational motion to the nut screw 16 which is rotatable with respect to the casing 2 about the actuating axis 7 but stationary in translation with respect to the casing 2, the planetary carrier 16 is integral in rotation with the screw 12, also integral in translation with the casing 2, and the nut screw 10 is integral in rotation with the casing 2, but can translate with respect to the casing 2 along the actuating axis 7, in which the nut screw 10 transmits its translational movement to the actuating member 6.

According to an embodiment (FIGS. 2, 3), the external thread 13 of the screw 12 has a first pitch and a first number of starts, the external thread 15 of the planetary screws 14 has a second pitch and a second number of starts, and the internal thread 11 of the nut screw 10 has a third pitch and a third number of starts. Advantageously, the first pitch and the third pitch are both greater than the second pitch and the first number of starts and the third number of starts are both greater than the second number of starts. This allows transmitting the axial force on a high number of ridges, in all cases containing the diameter of the planetary screws 14.

Preferably, the first pitch and the third pitch are identical, e.g. about 4 mm, and the second pitch is, for example about 1 mm, the first number of starts and the third number of starts are identical, e.g. about 4 (therefore with an apparent pitch of 1 mm), and the second number of starts is for example 1.

In a preferred embodiment, the ratio D10:D12:D14 between the diameters D10 of the nut screw (10), D12 of the screw (12) and D14 of the planetary screws (14) is 4:2:1 and with this ratio, the number of planetary screws 14 is preferably 7 or 8, thus obtaining a relative maximization of the number of contact points of the overall contact surface, as well as the overall thread cutting surface for the transmission of the axial thrust.

According to an embodiment, the screw 12 is internally hollow along at least 40%, preferably along more than 50%, of its total length, to make the mechanism lighter.

In an embodiment, on the side opposite to that of the actuating member 6, the screw 12 forms a rear end 37 for coupling with the last reduction stage of the reducer 23, and a reaction flange 38 which abuts against a shoulder 32 of the casing 2, possibly by means of the interposition of an axial bearing (slewing wheel or thrust bearing) 39 to further minimize the friction and the respective energy losses.

In an embodiment, the screw 12 is centered and is rotatably driven with respect to the casing 2, in particular with respect to a first tubular portion 31, by means of a radial bearing 40 interposed therebetween. Preferably, the radial bearing 40 is positioned in a region between the reaction flange 38 and the nut screw 10. This reduces the cantilevering screw effect and increases the centering and rotational support accuracy of the radial bearing 40.

In an embodiment, the planetary carrier 16 comprises two rings 41 each forming a group of axial holes which accommodate the ends of the planetary screws 14 and define the planetary rotation axes 17. The planetary carrier 16 is accommodated inside the nut screw 10 and its translation with respect to the nut screw 10 is either blocked or restricted within a tolerance stroke of a few tens of a millimeter or a few millimeters by containment or closing means arranged at the two opposite ends of the nut screw 10, e.g. a containing plate 42 blocked to the nut screw 10 by means of a Seeger ring 42′.

The ring gears 28 are accommodated in corresponding internal circumferential grooves of the nut screw 10, formed at the two opposite ends of the nut screw 10, but preferably on an axially internal side with respect to the perforated rings 41.

The ring gears 28 can rotate freely with respect to the nut screw in order to reduce friction and to prevent jamming of the conversion mechanism 9. Alternatively, the ring gears 28 can be locked to the nut screw with the effect of a greater rigidity and translational speed described above.

The nut screw 10 can be provided with two annular sliding shoes 43 (precision machined and made of a material suitable for sliding) in contact with an internal surface of the casing 2, in particular with the first tubular portion of metal 31.

To prevent respective rotation between the nut screw 10 and the casing 2, in particular the first metallic tubular portion 31, in which an axial guiding key 44 is provided in an appropriate housing of the casing 2 and which engages with a corresponding axial guiding groove 45 formed in the external surface of the nut screw 10.

Advantageously, the position and the length of the axial guiding key 44 is chosen so as to interfere with only one of the two sliding blocks 43 (which must therefore be interrupted), so that the other sliding shoe 43 does not need to be interrupted.

The actuating member 6 can be directly screwed with a front end of the nut screw 10 and may replace the aforesaid containing or closing means (Seeger ring 42′, holding plate 42) on the front side of the nut screw 10.

The conversion mechanism 9 can convert a rotation into a translation and, in doing so, demultiply the motion speed and therefore act as a single or further reduction mechanism.

Detailed Description of the Casing 2

According to an embodiment, the casing 2 with a grip-shaped portion 18 and possibly a coupling portion 19 for connecting, preferably by snapping, a replaceable and rechargeable electrical accumulator 4. The electric motor 3 which can be powered by the accumulator 4 by means of a power and control circuit 20 which comprises a switch on which a manual actuating button 21 arranged adjacent to the grip 18 acts.

Advantageously, the grip portion 18 of the casing 2 extends about the electric motor 3 and preferably along the motor rotation axis 22 which can either coincide or be parallel with the actuating 7 and/or with the axis of the screw 12 and of the nut screw 10.

Advantageously, the grip portion 18 of the casing 2 also extends around the reduction and conversion mechanism 5, preferably also at least partially about the conversion mechanism 9.

Advantageously, the length of an axial stroke of the conversion mechanism 9 as well as the axial length of the nut screw 10 and of the planetary screws 14 are either contained in the length of the grip portion 18, or extend beyond the grip portion 18 for less than 20%, preferably for less than 15% of the length of the grip portion 18.

This increases the ergonomics of the tool by positioning the center of the weight of the conversion mechanism 9 inside the grip portion 18 and by virtue of the fact of being able to place the working head 8 (also made of steel and therefore heavy) at least near the grip 18.

According to an embodiment, the reduction and conversion mechanism 5 is accommodated inside a tubular portion of the casing 2, said tubular portion having:

at least a first metallic (tubular) portion 31, which accommodates the conversion mechanism 9 and which forms an internal metallic shoulder 32 which acts as reaction abutment for the axial thrust applied to the actuating member 6, as well as

a second (tubular) portion 33 preferably (but not necessarily) made of plastic or composite synthetic material, which accommodates at least partially the reduction gear 23 and which is not subject to axial reaction stresses of the axial thrust applied to the actuating member 6.

Advantageously, the first tubular portion 31 comprises:

a front tube 31′ with a front passage opening 35 either in or through which the actuating member 6 extends, and

a rear tube 31″ which forms the shoulder 32 and a rear passage opening 36 either in or through which the reducer 23 connects to the conversion mechanism 9.

The front tube 31′ and the rear tube 31″ are mutually connected, e.g. by directly screwing one onto the other or by screwing connecting members, preferably in a removable manner, so as to accept and encapsulate the conversion mechanism 9 therebetween and to make the reaction abutment for the axial thrust applied to the actuating member 6.

The second portion 33 is connected, preferably in removable manner, to the first metallic portion 31, in particular to the rear pipe 31″, e.g. means of connecting screws 34, so as to accommodate and encapsulate the reduction mechanism 23 therebetween.

This facilitates the assembly of the tool 1, makes it lighter (by virtue of the second portion 33 made of plastic), and allows a selective access to the single components of the reduction and conversion mechanism 5 for the purposes of maintenance and repair.

Detailed Description of the Working Head 8

The working head 8 can comprise two jaws 24 connected (to each other and/or to the casing 2, e.g. at a front end of the tool 1) so as to be able to move (e.g. by sliding or rotating) relative to one another in response to the translational movement of the actuating member 6.

In one advantageous embodiment, the actuating member 6 is permanently elastically biased (e.g. by means of a return spring 25) towards a rest position, e.g. retracted position (FIG. 2) in which the working head 8 or the jaws 24 are in the open position or may be open to receive the object to compress or cut. This facilitates a return stroke of the actuating member 6 and of the jaws 24 and avoids the need to connect the actuating member 6 in fixed manner to the reduction and conversion mechanism 9.

In a further advantageous embodiment, the working head 8 or the jaws 24 are permanently elastically biased (e.g. by means of a closing spring 26) towards a closed position, adapted to engage or elastically clamp the object to compress or cut, and in which the working head 8 or the jaws 24 form one or more manual opening portions, e.g. lever portions 27 lead-in tracks adapted to spread the working head 8 or the jaws 24 as they are pushed against the object to compress or cut. This facilitates a manual positioning with temporary engagement of the working head 8 on the object to compress or cut.

As shown, for example, in FIG. 1, the actuating member 6 can act on the working head 8 or on the jaws 24 via the interposition of further rolling bodies, e.g. rollers.

The tool 1 is preferably a portable tool and can be used manually, e.g. a bar-shaped (or line) tool or a gun-shaped tool.

So, in general terms, the invention also relates to a hand-held tool (1) manually operable to compress or cut, said tool (1) being shaped as an elongated bar or as a gun and comprising:

a casing (2) which forms a grip portion,

a motor (3) supported by the casing (2),

a reduction and conversion mechanism (5) supported by the casing (2) and connected to the motor (3) and to an actuating member (6), wherein the reduction and conversion gear (5) is configured to make the actuating member (6) translate along an actuating axis (7) in response to a rotational motion of the motor (3),

a working head (8) connected to the casing (2) and which interacts with the actuating member (6) so that the working head (8) performs a compression or cutting movement in response to the translation of the actuating member (6),

wherein the reduction and conversion mechanism (5) comprises a conversion mechanism (9) with a planetary roller screw 10, 12, 14.

According to a further embodiment (FIGS. 7 to 12), the tool 1 comprises a safety clutch 46 connected to the reduction and conversion mechanism 5 and configured so as to automatically uncouple the rotational motion of the motor 3 from the motion of the actuating member 6 at the overcome of a torque setting of the safety clutch 46.

This avoids an undesired increase of the electric stress of the motor 3 and the mechanical stresses of the reduction and conversion mechanism 5, of the actuating member 6 and of the working head 8 after the completion of the compression or cutting, at jaws already connected therebetween, but before turning off the motor 3.

According to a particularly advantageous embodiment, the power supply and control circuit 20 comprises a detecting device 47 which detects the activation of the safety clutch 46 and automatically turns the electric motor 3 off according to the activation of the safety clutch 46, i.e. when it decouples the motion of the motor 3 from the movement of the actuating member 6.

In this manner, in addition to protect the components of the tool 1 from excessive stress and wear a reduction of energy consumption for the electrical supply of the motor 3 is also obtained.

According to an embodiment, the detecting device 47 detects one or more electrical quantities of the electric motor 3, preferably the current, and the control and power circuit 20 is configured to either detect or recognize the activation of the safety clutch 46 according to one or more electrical quantities of the motor 3 detected, e.g. the current.

The activation of the safety clutch 46 involves, for example, a sudden drop of the resisting torque or a repeated alternation of increases and decreases of the resisting torque, and therefore of the electric power drawn by the motor 3, e.g. identifiable by monitoring the current of the electric motor 3.

According to an embodiment, the safety clutch 46 is a rotary clutch which forms an elastic snapping or multiple snapping engagement and disengagement. Such a clutch achieves the decoupling by repeated relative snap slippage which can be easily detected by the user, in particular audible, and easily recognizable by interpreting the electrical parameters of the electric motor 3.

The safety clutch 46 may be configured to act on the epicyclic reduction gear 23, preferably on the last reduction stage of the epicyclic reduction gear 23.

According to an embodiment, the reduction step of the epicyclic reduction gear 23 on which the safety clutch 46 acts, comprises an internally toothed external ring gear 48 with which the planetary gears 49 mesh rotatably supported by a portion of planetary carrier 50 of the next stage of the epicyclic reduction gear 23 or of the rear end 37 of the screw 12. The planetary ring gears 49, in turn, mesh with a central toothed wheel 51, e.g. a central output ring gear of a reduction stage immediately upstream or to a central toothed wheel of the electric motor 3. The crown gear 48 is rotationally supported in the casing 2 and the rotation of the ring gear 48 relative to the casing 2 is (elastically) locked and unlocked by means of the safety clutch 46.

In this manner, when the ring gear 48 is locked and cannot rotate with respect to the casing 2, a rotation of the central ring gear 51 makes the planetary gears 49 rotate about their own axis and makes them orbit about the axis 22 of the epicyclic reduction gear 23 so as to transmit a rotation to the portion of planet carrier 50. When the ring gear 48 is unlocked and can rotate with respect to the casing 2, a rotation of the central ring gear 51 can make the planetary gears 49 rotate about their own axis without letting them orbit about the axis 22 of the epicyclic reduction gear 23, making instead the ring gear 48 rotate, consequently without transmitting rotation to the portion of planetary carrier 50 which supports the planetary gears 49.

Locking and unlocking the rotation of the ring gear 48 using the safety clutch 46, instead of inserting the clutch between two consecutive stages of the transmission mechanism, makes it possible to apply the safety clutch 46 to an existing tool without having to modify its motion transmission design.

According to an embodiment, the ring gear 48, preferably of the last stage of the transmission of the epicyclic reduction gear 23, forms an undulated cam track 52 against which rolling members 53 are rested, e.g. balls or rollers, and elastically biased by at least one spring 62 to lock the ring gear 48 with respect to the casing 2. At the overcome of the torque setting of the safety clutch 46, the wedge effect of the undulated cam track 52 moves the rolling members 53 against the elastic bias of the spring 62, allowing the rotation of the ring gear 48 relative to the casing 2.

Advantageously, the undulated cam track 52 is formed on a front surface of the ring gear 48 facing axial direction and the rolling members 53 are biased in the same axial direction with respect to the axis 22 of the epicyclic reduction gear 23. This reduces the radial dimension of the safety clutch 46.

In a preferred embodiment, the safety clutch 46 comprises a cup-shaped clutch casing 54 with a circumferential wall 55 and a bottom wall 56. The clutch casing 54 can be locked integral in rotation with the casing 2, e.g. axially insertable into the casing 2 and is integral in rotation with it by virtue of a plurality of longitudinal ribs 57 formed on an external surface 58 of the circumferential wall 55 and which engage by shape corresponding longitudinal grooves 59 of the casing 2. The circumferential wall 55 of the clutch casing 54 internally defines a ring housing 60 in which the ring gear 48 is rotationally received. The bottom wall 56 of the clutch casing 54 forms a plurality of axial channels 61 which each accommodate one or more of the rolling members 53, preferably two balls in each axial channel 61, so that at least one rolling element 53 from the axial channel 61 protrudes in the seat ring 60 and abuts against the undulated cam track 52 of the ring gear 48. The rolling members 53 in the axial channels 61 are biased in engagement by pressing against the cam track 52 by means of the spring 62. The spring 62 may be, for example, a helical spring arranged outside the clutch casing 54 (in a spring seat 67 of the casing 2) and push, by means of the interposition of a washer 63 or of an axial bearing, against portions of the rolling members 53 projecting axially out of the clutch casing 54.

A fixing plate 64 screwed onto the casing 2 to lock the clutch casing 54 axially in the casing 2 of the tool 1 may be positioned on the side opposite to the bottom wall 56 of the clutch casing 54. An additional washer 65 or axial bearing may be interposed between the fixing plate 64 and the ring gear 48 to reduce the sliding friction therebetween. In addition, the fixing plate 64 may form a circular centering seat 66 for the additional washer 65 or axial bearing.

This facilitates the assembly of the safety clutch 46, reduces the radial dimension of the tool 1 and minimizes the additional axial dimension necessary to accommodate also the safety clutch 46.

The same fixing plate 64 may form, on the opposite side of the clutch casing 54, a further centering housing 68 to partially receive and center a further ring gear 69 of the epicyclic reduction gear 23, placed upstream with respect to the reduction stage on which the safety clutch 46 acts.

In general terms, the invention also relates to a hand-held tool (1) manually usable to compress or cut, said tool (1) being shaped as an elongated bar or as a gun and comprising:

a casing (2) which forms a grip portion,

a motor (3) supported by the casing (2),

a reduction and conversion mechanism (5) supported by the casing (2) and connected to the motor (3) and to an actuating member (6), wherein the reduction and conversion gear (5) is configured to make the actuating member (6) translate along an actuating axis (7) in response to a rotational motion of the motor (3),

a working head (8) connected to the casing (2) and which interacts with the actuating member (6) so that the working head (8) performs a compression or cutting movement in response to the translation of the actuating member (6),

wherein the tool 1 comprises a safety clutch 46 connected to the reduction and conversion mechanism 5 and configured so as to automatically uncouple the rotational motion of the motor 3 from the motion of the actuating member 6 to overcome a torque setting of the safety clutch 46,
wherein the power and control circuit 20 comprises a detecting device 47 which detects the activation of the safety clutch 46 and turns off the electric motor 3 automatically according to the detected activation of the safety clutch 46.

What is claimed is:

1-34. (canceled)

35. A compression or cutting tool (1) comprising:
a casing (2),
a motor (3) supported by the casing (2),
a reduction and conversion mechanism (5) supported by the casing (2) and connected to the motor (3) and to an actuating member (6), wherein the reduction and conversion mechanism (5) is configured to make the actuating member (6) translate along an actuating axis (7) in response to a rotational motion of the motor (3),
a working head (8) connected to the casing (2) and which interacts with the actuating member (6) so that the working head (8) performs a compression or cutting movement in response to a translation of the actuating member (6),
wherein the reduction and conversion mechanism (5) comprises a conversion mechanism (9) with:
a nut screw (10) with internal thread (11) or multiple internal circumferential groove,
a screw (12) coaxial and parallel with the nut screw (10), said screw (12) having an external thread (13) or multiple external circumferential groove not directly engaged with the nut screw (10),
a plurality of planetary screws (14) parallel to the nut screw (10) and interposed between the screw (12) and the nut screw (10), wherein each of the planetary screws (14) has an external thread (15) or multiple external circumferential groove engaging with the thread or multiple circumferential groove of the screw (12) and the nut screw (10),
a planetary carrier (16) which supports the planetary screws (14):
so that each planetary screw (14) can rotate around its own planetary axis (17) parallel to the nut screw (10), and
so that each planetary screw (14) is at a distance from the other planetary screws (16, 14) to prevent direct contact between them,
wherein the reduction and conversion mechanism (5) transmits an input rotational motion to one of said screw (12), nut screw (10), planetary carrier (16) or to the planetary screws (14), and a plurality of engagements between at least one of said threads (11, 13, 15) and a respective thread (15, 11, 13) or multiple circumferential groove of said screw (12), nut screw (10) and planetary screws (14) convert said input rotational motion into an output translational motion of at least one other of said screw (12), nut screw (10) and planetary carrier (16).

36. The compression or cutting tool (1) of claim 35, wherein ring gears (28) can rotate with respect to the nut screw (10), with respect to the screw (12) and also with respect to the planetary carrier (16).

37. The compression or cutting tool (1) of claim 35, wherein:
the reduction and conversion mechanism (5) transmits the rotational motion to the screw (12) which is rotational with respect to the casing (2) about the actuating axis (7) but stationary in translation with respect to the casing (2),
the planetary carrier (16) is integral in translation with the nut screw (10),
the nut screw (10) is integral in rotation with the casing (2) but translatable with respect to the casing (2) along the actuating axis (7), and
the nut screw (10) transmits its translational movement to the actuating member (6).

38. The compression or cutting tool (1) of claim 35, wherein:
the reduction and conversion mechanism (5) transmits the rotational motion to the planetary carrier (16) which is rotatable with respect to the casing (2) about the actuating axis (7) but stationary in translation with respect to the casing (2),
the planetary carrier (16) is integral in translation with the nut screw (10) and the nut screw (10) is integral in rotation with the casing (2),
the screw (12) is integral in rotation with the casing (2) but translatable with respect to the casing (2) along the actuating axis (7), and
the screw (12) transmits its translational movement to the actuating member (6).

39. The compression or cutting tool (1) of claim 35, wherein:
the reduction and conversion mechanism (5) transmits the rotational motion to the planetary carrier (16) which is rotatable with respect to the casing (2) about the actuating axis (7) but stationary in translation with respect to the casing (2),
the planetary carrier (16) is integral in translation with the screw (12) and the screw (12) is integral in translation with the casing (2),
the nut screw (10) is integral in rotation with the casing (2) but translatable with respect to the casing (2) along the actuating axis (7), and
the nut screw (10) transmits its translational movement to the actuating member (6).

40. The compression or cutting tool (1) of claim 35, wherein the external thread (13) of the screw (12) has a first pitch and a first number of starts, the external thread (15) of the planetary screws (14) has a second pitch and a second number of starts, and the internal thread (11) of the nut screw (10) has a third pitch and a third number of starts,
wherein the first pitch and the third pitch are both greater than the second pitch and the first number of starts and the third number of starts are both greater than the second number of starts.

41. The compression or cutting tool (1) of claim 40, wherein the first pitch and the third pitch are identical and are 4 mm, the second pitch is 1 mm, the first number of starts and the third number of starts are identical and are 4 and the second number of starts is 1.

42. The compression or cutting tool (1) of claim 35, wherein the ratio D10:D12:D14 between the diameter D10 of the nut screw (10), the diameter D12 of the screw (12) and the diameter D14 of the planetary screws (14) is 4:2:1 and the number of planetary screws (14) is chosen from 7 and 8.

43. The compression or cutting tool (1) of claim 35, wherein the screw (12) is internally hollow along at least 40% of its total length.

44. The compression or cutting tool (1) of claim 35, wherein:
the nut screw (10) comprises two annular sliding shoes (43) in contact with an internal surface of the casing (2),
an axial guide key (44) is fixed in a seat of the casing (2) and which engages a corresponding axial guide groove (45) in the external surface of the nut screw (10), and
the position and the length of the axial guide key (44) is chosen so as to interfere with only a first shoe of the two annular sliding shoes (43), said first shoe being interrupted at the axial guide key (44), while a second shoe of said two annular sliding shoes (43) is not interrupted.

45. The compression or cutting tool (1) of claim 35, wherein the casing (2) forms a grip-shaped portion (18) and a coupling portion (19) for connecting to an electric accumulator (4), which can be replaced and recharged, wherein the motor (3) is electrically powered and can be controlled by means of a power supply and control circuit (20) which comprises a switch on which a manual actuating button (21) arranged adjacent to the grip portion (18) acts.

46. The compression or cutting tool (1) of claim 45, wherein the grip portion (18) of the casing (2) extends about the electric motor (3) and along the motor rotation axis (22) which is either parallel or coaxial with the actuating axis (7) and with the axis of the screw (12) and the nut screw (10).

47. The compression or cutting tool (1) of claim 46, wherein the grip portion (18) also extends about the reduction and conversion mechanism (5) and at least partially about the conversion mechanism (9).

48. The compression or cutting tool (1) of claim 47, wherein the axial stroke of the conversion mechanism (9) and the axial length of the nut screw (10) and of the planetary screws (14) are contained within the length of the grip portion (18).

49. The compression or cutting tool (1) of claim 46, wherein axial travel of the conversion mechanism (9) and the axial length of the nut screw (10) and of the planetary screws (14) extend beyond the grip portion (18) for less than 20%, preferably for less than 15%, of the length of the grip portion (18).

50. The compression or cutting tool (1) of claim 35, wherein the reduction and conversion mechanism (5) is received inside a tubular portion of the casing (2), said tubular portion having:
at least a first metallic portion (31) which accommodates the conversion mechanism (9) and which forms an internal metallic shoulder (32) which acts as a reaction abutment for an axial thrust applied to the actuating member (6), and
a second portion (33) made of plastic which accommodates at least partially the reduction gear (23) and which is not subject to axial reaction stresses of the axial thrust applied to the actuating member (6).

51. The compression or cutting tool (1) of claim 50, wherein the first portion (31) comprises:
a front tube (31′) with a front passage opening (35) either in or through which the actuating member (6) extends, and
a rear tube (31″) which forms the internal metallic shoulder (32) and a rear passage opening (36) either in or through which the reducer (23) connects to the conversion mechanism (9),
wherein the front tube (31′) and the rear tube (31″) are mutually connected so as to receive and encapsulate the conversion mechanism (9) therebetween and to make the reaction abutment for the axial thrust applied to the actuating member (6).

52. The compression or cutting tool (1) of claim 35, comprising a safety clutch (46) connected to the reduction and conversion mechanism (5) and configured so as to automatically uncouple the rotational motion of the motor (3) from the motion of the actuating member (6) when a torque setting of the safety clutch (46) is overcome,
wherein a power and control circuit (20) of the compression or cutting tool (1) comprises a detecting device (47) which detects the activation of the safety clutch (46) and turns off the electric motor (3) automatically according to the activation of the safety clutch (46).

53. The compression or cutting tool (1) of claim 52, wherein the detecting device (47) detects one or more electrical quantities of the electric motor (3), e.g. current, and the control and power circuit (20) is configured to either detect or recognize the activation of the safety clutch (46) according to one or more electrical quantities of the motor (3) found.

54. A hand-held tool (1) manually operable to compress or cut, said tool (1) being shaped as an elongated bar or as a gun and comprising:
a casing (2) which forms a grip portion,
a motor (3) supported by the casing (2),
a reduction and conversion mechanism (5) supported by the casing (2) and connected to the motor (3) and to an actuating member (6), wherein the reduction and conversion gear (5) is configured to make the actuating member (6) translate along an actuating axis (7) in response to a rotational motion of the motor (3),
a working head (8) connected to the casing (2) and which interacts with the actuating member (6) so that the working head (8) performs a compression or cutting movement in response to the translation of the actuating member (6),
wherein the tool (1) comprises a safety clutch (46) connected to the reduction and conversion mechanism (5) and configured so as to automatically uncouple the rotational motion of the motor (3) from the motion of the actuating member (6) when a preset torque of the safety clutch (46) is overcome, and
wherein the power and control circuit (20) comprises a detecting device (47) which detects the activation of the safety clutch (46) and turns off the electric motor (3) automatically according to the activation of the safety clutch (46).
